(19) United States
(12) Patent Application Publication
(10) Pub. No.: US 2015/0358321 A1
(43) Pub. Date: Dec. 10, 2015

(54) STORAGE DEVICE, INFORMATION PROCESSING APPARATUS, AND INFORMATION PROCESSING METHOD

(71) Applicant: Kabushiki Kaisha Toshiba, Tokyo (JP)

(72) Inventors: Hiroki Udagawa, Kawasaki Kanagawa (JP); Yoshiyuki Kudoh, Kawasaki Kanagawa (JP); Taichiro Yamanaka, Hino Tokyo (JP); Yasuto Aramaki, Kawasaki Kanagawa (JP); Teruji Yamakawa, Chuo Tokyo (JP); Kentaro Umesawa, Kawasaki Kanagawa (JP); Sachi Tarui, Ota Tokyo (JP)

(21) Appl. No.: 14/481,535

(22) Filed: Sep. 9, 2014

(30) Foreign Application Priority Data
Jun. 10, 2014 (JP) 2014-119547

(51) Int. Cl. H04L 29/06; H04L 9/32

(52) U.S. Cl. CPC H04L 63/0876; H04L 9/3247

(57) ABSTRACT

According to embodiments, a storage device includes a storage unit, a receiving unit, an authenticating unit, and a control unit. Prior to executing erasure processing of data that has been stored in the storage unit, the receiving unit receives, from an external device that clocks time, third information including first information and second information, the first information regarding time counted by the external device and the second information being information for authenticating the external device. The authenticating unit performs authentication processing of the external device by using the second information included in the third information. When the authentication of the external device has succeeded, the control unit generates an erasure log that contains erasure time when the erasure processing has been executed on the basis of the first information included in the third information. When the authentication of the external device has failed, the execution of the erasure processing is prohibited.

### CROSS-REFERENCE TO RELATED APPLICATIONS

This application is based upon and claims the benefit of priority from Japanese Patent Application No. 2014-119547, filed on Jun. 10, 2014; the entire contents of which are incorporated herein by reference.

### FIELD

Embodiments described herein relate generally to a storage device, an information processing apparatus, and an information processing method.

### BACKGROUND

Data stored in a storage device includes data such as personal information and secret information. Thus, handling of the data requires great care. In particular, erasure of data has to be performed securely at the time of disposing of storage devices or erasing data stored in the storage devices; otherwise the data might be restored and abused unless the data has been thoroughly erased. In services such as data center services, for example, where data of various users are stored in the storage devices, it is especially necessary to erase the data securely at the time of terminating a contract with a user or discarding the storage devices owned by the data center and show the user that the erasure of data has been securely completed.

In the operation of the data center in the past, a host server connected to the storage device erases data, and, to show the secure erasure of the data, provides the user with an erasure certificate such as erasure log which contains information of time when the data has been erased.

### BRIEF DESCRIPTION OF THE DRAWINGS

FIG. 1 is a block diagram illustrating a structure of a storage system according to a first embodiment;

FIG. 2 is a block diagram illustrating a hardware structure of a host server according to the first embodiment;

FIG. 3 is a block diagram illustrating a hardware structure of a time server according to the first embodiment;

FIG. 4 is a block diagram illustrating a functional structure of the storage device according to the first embodiment;

FIG. 5 is a sequence diagram illustrating a flow of transmission processing of erasure certificate data to a client terminal in the storage system according to the first embodiment;

FIG. 6 is a flowchart illustrating a flow of receiving processing of response data by the storage device according to the first embodiment;

FIG. 7 is a flowchart illustrating a flow of erasure processing by the storage device according to the first embodiment;

FIG. 8 is a flowchart illustrating a flow of transmission processing of erasure certificate data by the storage device according to the first embodiment;

FIG. 9 is a flowchart illustrating a flow of transmission processing of response data by the time server according to the first embodiment;

FIG. 10 is a flowchart illustrating a flow of transmission processing of response data by the host server according to the first embodiment;

FIG. 11 is a flowchart illustrating a flow of transmission of an execute instruction of the erasure processing by the host server according to the first embodiment; and

FIG. 12 is a flowchart illustrating a flow of transmission processing of the erasure certificate data by the host server according to the first embodiment.

### DETAILED DESCRIPTION

A storage device according to an embodiment comprises a storage unit, a receiving unit, an authenticating unit, and a control unit. Prior to executing erasure processing of data that has been stored in the storage unit, the receiving unit receives, from an external device that clocks time, third information including first information and second information, the first information regarding time counted by the external device and the second information being information for authenticating the external device. The authenticating unit performs authentication processing of the external device using the second information included in the third information. When the authentication of the external device has succeeded, the control unit generates an erasure log that contains erasure time when the erasure processing has been executed on the basis of the first information included in the third information. When the authentication of the external device has failed, the execution of the erasure processing is prohibited.

A storage system applied with a storage device, an information processing apparatus, and an information processing method will be described below by referring to the accompanying drawings.

### First Embodiment

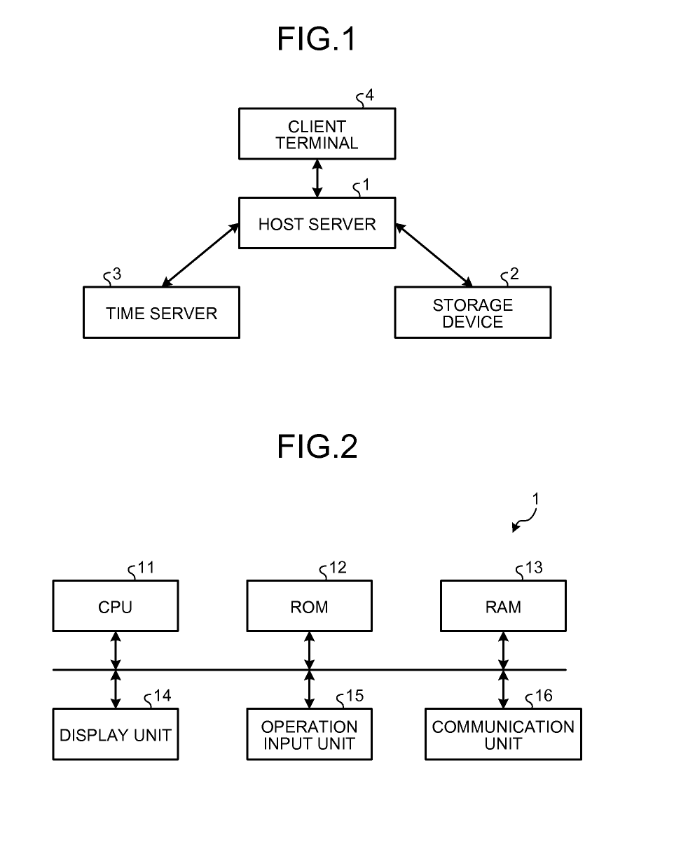

FIG. 1 is a block diagram illustrating a structure of a storage system according to a first embodiment. The storage system according to the present embodiment includes, as illustrated in FIG. 1, a host server 1, a storage device 2, a time server 3, and a client terminal 4. The client terminal 4 can output an erasure instruction of data which is stored in the storage device 2.

The host server 1 (an example of information processing apparatus) receives an erasure instruction (an example of first instruction) of data in the storage device 2 (an example of storage device or external storage device) from the client terminal 4, and sends the erasure instruction to the storage device 2. The storage device 2 executes the erasure processing of the data stored in the storage device 2 in response to the erasure instruction input from the host server 1, and can generate a log of the erasure processing (hereinafter referred to as an erasure log). The time server 3 (an example of external device) clocks time, and provides, to the storage device 2, time information or the like which is an example of the first information regarding the counted time and used for generating the erasure log in the storage device 2.

The time information is an example of first information regarding the counted time, as described above. In the present embodiment, the time information represents information that indicates time corresponding to timing when the time information has been received by the storage device 2. The time information, however, is not limited thereto, and any information may be used so long as the information is of the counted time. For example, if an exact time is not needed for generating the erasure log, the time information may be information indicating that the time corresponding to the timing of the receiving time information by the storage device 2 belongs to a time range of preset multiple time ranges.

In the present embodiment, the host server 1 intermediates transmission and reception of various types of information, such as the time information, between the storage device 2 and the time server 3. The host server 1, however, is not limited thereto, and various types of information may also be exchanged between the storage device 2 and the time server 3 without passing through the host server 1.

FIG. 2 is a block diagram illustrating a hardware structure of the host server according to the first embodiment. In the present embodiment, the host server 1 may be formed by a personal computer (PC) or the like, and includes, as illustrated in FIG. 2, a central processing unit (CPU) 11, read only memory (ROM) 12, random access memory (RAM) 13, a display unit 14, an operation input unit 15, and a communication unit 16.

The CPU 11 executes various programs that have been previously stored in the ROM 12 by operating a predetermined storage area in the RAM 13 as a working area, to thereby control each unit of the host server 1. The ROM 12 stores various types of information such as the various programs according to the control of the host server 1. The RAM 13 functions as the working area of the CPU 11.

The display unit 14 is formed, for example, by a liquid crystal display (LCD) or the like, and is controlled by the CPU 11 to display various types of information. The display unit 14 may also be a touch panel display which is capable of detecting touch operations on the display screen of the display unit 14. The operation input unit 15 is formed, for example, by a mouse or a keyboard, with which a user can input various information.

The communication unit 16 can communicate with the external device, such as the storage device 2 or the time server 3 which is connected to the communication unit 16 with the network which is not illustrated.

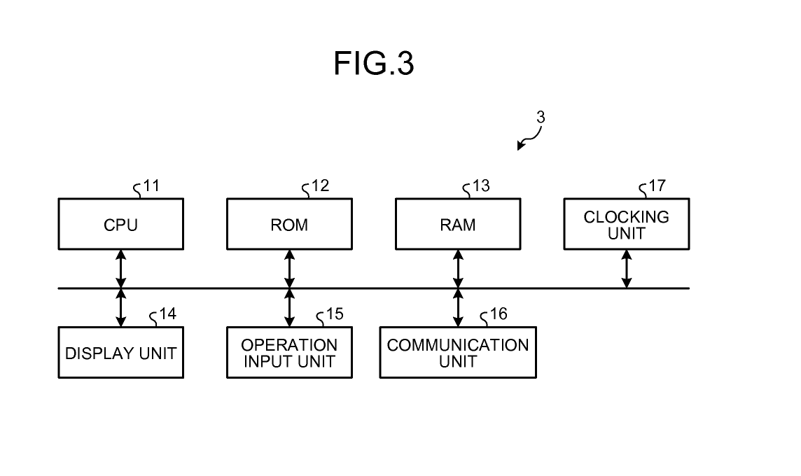

FIG. 3 is a block diagram illustrating a hardware structure of the time server according to the first embodiment. In the description below, portions of the hardware structure of the time server 3, which are similar to those of the host server 1, may not be described repeatedly. In the present embodiment, the time server 3 is different from the host server 1 in that a clocking unit 17 is added to the hardware structure, as illustrated in FIG. 3. The clocking unit 17 is formed, for example, by a real time clock (RTC), and counts time.

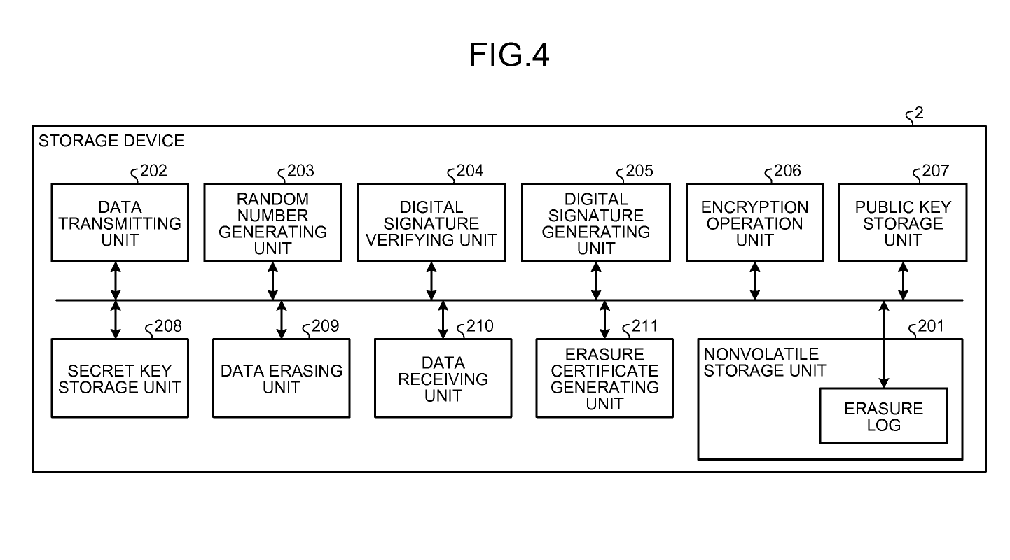

FIG. 4 is a block diagram illustrating a functional structure of the storage device according to the first embodiment. In the present embodiment, the storage device 2 includes, as illustrated in FIG. 4, a nonvolatile storage unit 201, a data transmitting unit 202, a random number generating unit 203, a digital signature verifying unit 204, a digital signature generating unit 205, an encryption operation unit 206, a public key storage unit 207, a secret key storage unit 208, a data erasing unit 209, a data receiving unit 210, and an erasure certificate generating unit 211.

The nonvolatile storage unit 201 (an example of storage unit) is formed, for example, by a magnetic disc or flash memory, and stores various programs or data (such as an erasure log) according to the control of the storage device 2 in a rewritable and nonvolatile manner.

The data transmitting unit 202 (an example of transmitting unit) sends various types of information, such as challenge data, an authentication result, a notice of completion of erasure processing, and erasure certificate data, to the host server 1. The challenge data is used to request transmission of the time information to the time server 3, and includes random numbers (hereinafter referred to as first random numbers) by the random number generating unit 203. The authentication result represents a result of the authentication processing of the time server 3 which is a sender of the time information. The notice of completion of the erasure processing represents the completion of the erasure processing of data stored in the nonvolatile storage unit 201. The erasure certificate data includes the erasure log of the erasure processing of data stored in the nonvolatile storage unit 201.

The data receiving unit 210 receives from the host server 1 various types of information, such as a start instruction of a challenge response, an execution instruction of the erasure processing, and a request for transmission of the erasure certificate data. The start instruction of the challenge response is information to instruct transmission of the challenge data and the start of receiving the response data which will be described later. The execution instruction of the erasure processing is information to instruct the execution of the erasure processing. The request for transmission of the erasure certificate data is information to instruct transmission of the erasure log.

The data receiving unit 210 (an example of receiving unit) receives the response data from the time server 3 via the host server 1. The response data is an example of third information including the authentication information (an example of the second information) to authenticate the time information and the time server 3 which is the sender of the time information. In the present embodiment, the data receiving unit 210 receives response data that has been obtained by encrypting the time information with a secret key stored in the time server 3, and includes a digital signature added as the authentication information.

The random number generating unit 203 (an example of generating unit) generates the first random numbers used to determine effectiveness of the response data received by the data receiving unit 210 for predetermined time (an example of second predetermined time).

The public key storage unit 207 stores the public key used for decryption of the authentication information included in the response data received by the data receiving unit 210. The secret key storage unit 208 stores the secret key used for encryption when adding the digital signature on the erasure log that is to be sent to the host server 1.

The encryption operation unit 206 obtains information obtained by decrypting the digital signature added to the response data, which has been received by the data receiving unit 210 as the authentication information, by using the public key stored in the public key storage unit 207. The encryption operation unit 206 also obtains the digital signature to be added to the erasure log when generating the erasure certificate data in the erasure certificate generating unit 211 by encrypting the entire erasure log using the secret key stored in the secret key storage unit 208.

The digital signature verifying unit 204 performs the authentication processing of the time server 3, which is the sender of the response data, using the authentication information included in the response data received by the data receiving unit 210. In the present embodiment, the digital signature verifying unit 204 determines success of the authentication of the time server 3 when the time information included in the response data received by the data receiving unit 210 matches the information obtained by decrypting the digital signature added to the response data as the authentication information (that is, the information decrypted by the encryption operation unit 206). Meanwhile, the digital signature verifying unit 204 determines failure of the authentication of the time server 3 when the time information included in the response data received by the data receiving unit 210 does not match the information obtained by decrypting the digital signature added to the response data as the authentication information. That is, in the present embodiment, the encryption operation unit 206 and the digital signature verifying unit 204 function as an example of authenticating unit.

When the authentication of the time server 3 has succeeded, the data erasing unit 209 executes the erasure processing of data stored in the nonvolatile storage unit 201 in response to the execution instruction of the erasure processing received by the data receiving unit 210. In the present embodiment, the data erasing unit 209 included in the storage device 2 executes the erasure processing of the data stored in the nonvolatile storage unit 201, but it is not limited thereto, and the external device such as the host server 1 can execute the erasure processing of the data stored in the nonvolatile storage unit 201. When the authentication of the time server 3 has failed, the data erasing unit 209 prohibits execution of the erasure processing of the data stored in the nonvolatile storage unit 201.

When the authentication of the time server 3 has succeeded, the erasure certificate generating unit 211 generates, in response to the request for transmission of the erasure certificate data received by the data receiving unit 210, the erasure log that includes the erasure time when the erasure processing has been executed on the basis of the time information included in the received response data. Accordingly, the erasure log including the highly reliable erasure time can be generated in the storage device 2 to which illegal access is difficult, and the highly reliable erasure log can be provided even when the illegal access is made to the host server 1. In the present embodiment, the data erasing unit 209 and the erasure certificate generating unit 211 function as an example of the control unit.

When the erasure processing has been executed by the data erasing unit 209, the digital signature generating unit 205 adds the digital signature obtained by the encryption operation unit 206 to the erasure log that has been generated by the erasure certificate generating unit 211. Thus, tampering of the erasure log that has been generated by the erasure certificate generating unit 211 can be prevented.

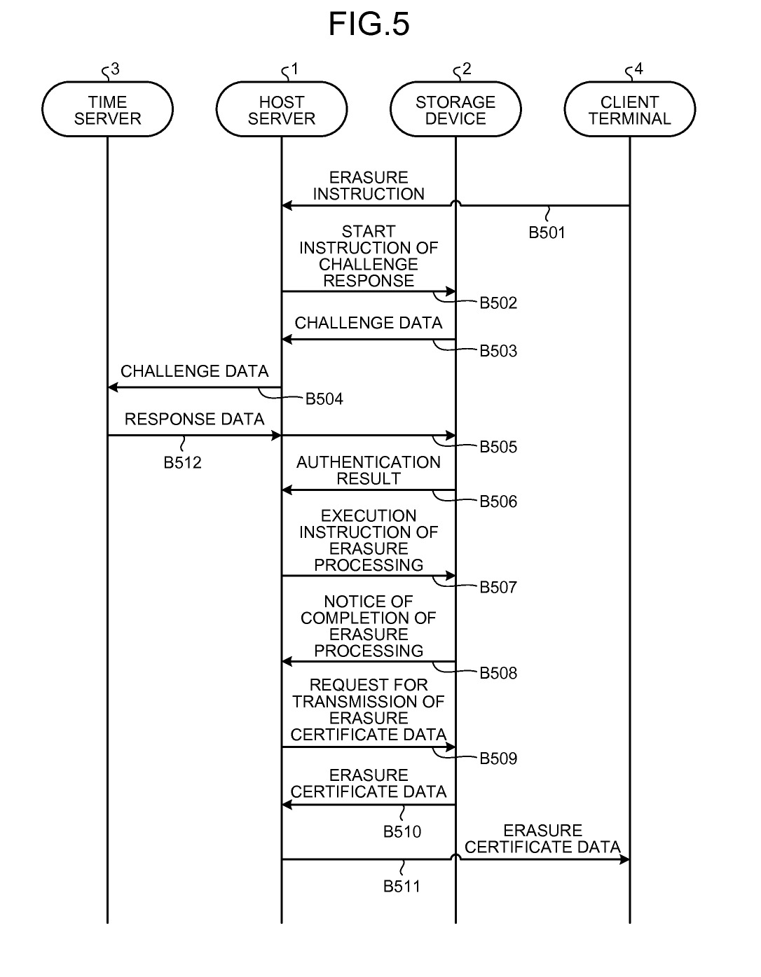

Next, by referring to FIG. 5, transmission processing of the erasure certificate data to the client terminal in the storage system according to the present embodiment will be described. FIG. 5 is a sequence diagram illustrating a flow of transmission processing of the erasure certificate data to a client terminal in the storage system according to the first embodiment.

The CPU 11 of the host server 1 controls the communication unit 16 to receive the erasure instruction from the client terminal 4 (B501). In response to the erasure instruction from the client terminal 4, the CPU 11 of the host server 1 sends a start instruction of the challenge response to the storage device 2 (B502).

When the data receiving unit 210 receives the start instruction of the challenge response from the host server 1, the data transmitting unit 202 of the storage device 2 generates challenge data including the first random numbers generated by the random number generating unit 203. The data transmitting unit 202 sends the generated challenge data to the time server 3 via the host server 1 (B503, B504).

In response to the challenge data which is received from the storage device 2 via the host server 1 by controlling the communication unit 16, the CPU 11 of the time server 3 generates response data. The CPU 11 of the time server 3 then controls the communication unit 16 to send the generated response data to the storage device 2 via the host server 1 (B512, B505).

Prior to the execution of erasure processing, the data receiving unit 210 of the storage device 2 receives the response data from the time server 3 via the host server 1 (B505). The digital signature verifying unit 204 of the storage device 2 uses the authentication information included in the received response data to execute the authentication processing on the time server 3 which is the sender of the response data. The data transmitting unit 202 of the storage device 2 sends to the host server 1, as an authentication result, a result of the authentication processing of the time server 3 by the digital signature verifying unit 204 (B506).

When the authentication result sent from the storage device 2 indicates a success of authentication of the time server 3, the CPU 11 of the host server 1 controls the communication unit 16 to send an execution instruction of the erasure processing to the storage device 2 (B507).

In response to the execution instruction sent from the data receiving unit 210, the data erasing unit 209 of the storage device 2 executes the erasure processing of data stored in the nonvolatile storage unit 201. The data transmitting unit 202 of the storage device 2 then sends a notice of completion of the erasure processing to the host server 1 (B508).

In response to the notice of completion of the erasure processing sent from the storage device 2, the CPU 11 of the host server 1 controls the communication unit 16 to send a request for transmission of erasure certificate data to the storage device 2 (B509).

In response to the request for transmission of the erasure certificate data sent from the data receiving unit 210, the erasure certificate generating unit 211 of the storage device 2 generates an erasure log. The data transmitting unit 202 of the storage device 2 sends the generated erasure log to the host server 1 as the erasure certificate data (B510).

The CPU 11 of the host server 1 controls the communication unit 16 to send the erasure certificate data sent from the storage device 2 to the client terminal 4 (B511).

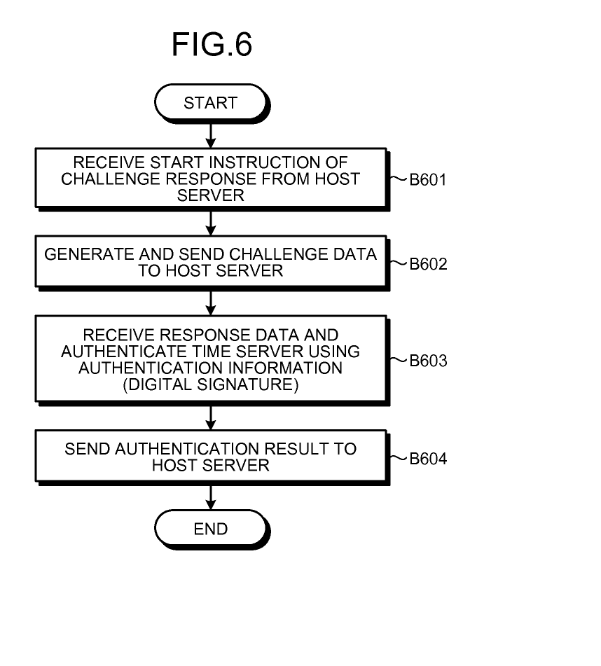

Next, by referring to FIG. 6, specific contents of the processing (the receiving processing of the response data by the storage device 2 according to the present embodiment) executed in the storage device 2 in B502 to B505 of FIG. 5 will be described. FIG. 6 is a flowchart illustrating a flow of the receiving processing by the storage device according to the first embodiment.

In the storage device 2, the data receiving unit 210 receives the start instruction of the challenge response from the host server 1 (B601). In response to the reception of the start instruction of the challenge response, the data transmitting unit 202 generates challenge data including the first random numbers that have been generated last by the random number generating unit 203 (B602). The data transmitting unit 202 sends the generated challenge data to the time server 3 via the host server 1 (B602).

Subsequently, the data receiving unit 210 receives the response data that has been sent from the time server 3 via the host server 1 (B603). The response data includes the data including the time information and the first random numbers which have been generated last by the random number generating unit 203, added with a digital signature generated by the time server 3. The digital signature verifying unit 204 uses the authentication information included in the received response data (the digital signature added to the received response data in the present embodiment) to execute the authentication processing of the time server 3 which is the sender of the response data (B603).

In the present embodiment, the encryption operation unit 206 decrypts the digital signature having been added to the received response data by using the public key stored in the public key storage unit 207. The digital signature verifying unit 204 determines that the authentication processing of the time server 3 has succeeded when the authentication of the decrypted digital signature has succeeded. When the authentication processing of the time server 3 has succeeded, the digital signature verifying unit 204 makes the nonvolatile storage unit 201 hold the time information included in the response data. If first predetermined time has passed after the reception of the response data without execution of the erasure processing, the digital signature verifying unit 204 erases the time information included in the response data from the nonvolatile storage unit 201. The first predetermined time is an upper limit of time required for the erasure processing of data stored in the nonvolatile storage unit 201.

Meanwhile, if the authentication processing of the decrypted digital signature has failed, the digital signature verifying unit 204 determines the failure of the authentication processing by the time server 3. The digital signature verifying unit 204 does not store the time information included in the received response data in the nonvolatile storage unit 201 and discards the response data.

The data transmitting unit 202 sends the authentication result representing the authentication processing by the digital signature verifying unit 204 to the host server 1 (B604).

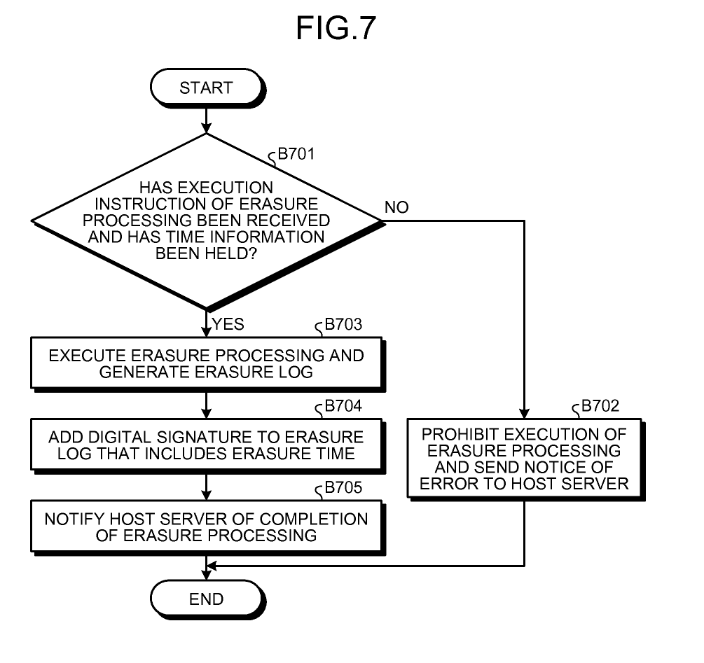

Next, by referring to FIG. 7, specific contents of the processing (the erasure processing by the storage device 2 according to the present embodiment) executed by the storage device 2 in B507 and B508 of FIG. 5 will be described. FIG. 7 is a flowchart illustrating a flow of the erasure processing by the storage device according to the first embodiment.

When the erasure processing of the time server 3 has succeeded, the data receiving unit 210 comes to wait for the execution instruction of the erasure processing from the host server 1. When data receiving unit 210 receives the execution instruction of the erasure processing from the host server 1, the data erasing unit 209 determines whether the time information included in the response data received at B603 of FIG. 6 is stored (held) in the nonvolatile storage unit 201 (B701).

In the present embodiment, if the first predetermined time has passed without executing the erasure processing after the response data has received, the digital signature verifying unit 204 erases the time information included in the response data from the nonvolatile storage unit 201 as described above. Therefore, if the time information included in the received response data is not stored in the nonvolatile storage unit 201 (B701: No), the data erasing unit 209 is not able to generate the erasure log, and the execution of the erasure processing is prohibited. The data transmitting unit 202 sends to the host server 1 a notice of error that represents unavailability of execution of the erasure processing (B702).

In particular, if the first predetermined time has passed without execution of the erasure processing since the reception of the response data, the data erasing unit 209 prohibits the execution of the erasure processing. This prevents prolonging a state where the execution of the erasure processing is available after the success of the authentication of the time server 3, which leads to prevention of the execution of the erasure processing due to illegal access to the storage device 2.

Meanwhile, when the time information included in the response data sent from the host server 1 is stored in the nonvolatile storage unit 201 (B701: Yes), the data erasing unit 209 executes the erasure processing of the data stored in the nonvolatile storage unit 201 (B703).

In the present embodiment, the data erasing unit 209 may permit execution of the erasure processing when the first random numbers included in the received response data match the first random numbers generated by the random number generating unit 203 between the time indicated by the time information included in the response data and preset time (an example of third predetermined time). In contrast, the data erasing unit 209 may not permit execution of the erasure processing unless the first random numbers included in the received response data match the first random numbers generated by the random number generating unit 203 between the time indicated by the time information included in the response data and preset time. Thus, the execution of the erasure processing can be prevented according to the reception of the response data that includes less reliable time information received after the extended time has passed since the transmission of the challenge data.

The erasure certificate generating unit 211 generates an erasure log of the erasure processing when the data erasing unit 209 has executed the erasure processing (B703). At this time, the erasure certificate generating unit 211 obtains the erasure time when the erasure processing is executed according to the time information stored in the nonvolatile storage unit 201 (that is, the time information included in the received response data), and generates the erasure log including the obtained erasure time.

In the present embodiment, the erasure certificate generating unit 211 generates the erasure log that includes time between the reception of the response data and the end of the erasure processing as the erasure time, with the time indicated by the time information stored in the nonvolatile storage unit 201 as a reference. In particular, the erasure certificate generating unit 211 obtains time, as the time between the reception of the response data and the end of the erasure processing, by subtracting energizing time of the storage device 2 at the end of the erasure processing from energizing time of the storage device 2 at the time of receiving the response data. The energizing time is a lapse of time after the storage device 2 is turned on. The erasure certificate generating unit 211 obtains, as the erasure time, the time when the obtained time has passed since the time indicated by the time information. Thus, the erasure time included in the erasure log can be more precise, and the erasure log including more reliable erasure time can be generated.

In the present embodiment, the erasure certificate generating unit 211 regards the erasure time as the time that has passed till the end of the erasure processing after the reception of the response data, according to the time indicated by the time information stored in the nonvolatile storage unit 201 as a reference. It is, however, not limited thereto, and the time indicated by the time information may be used as the erasure time. The erasure certificate generating unit 211 may use the time when the preset time required for the erasure processing has passed since the time indicated by the time information as the erasure time.

The erasure certificate generating unit 211 may also generate the erasure log that includes information capable of allowing the host server 1 to recognize the client terminal 4 which is the sender of the erasure instruction, or recognize the user of the client terminal 4.

Further, the encryption operation unit 206 obtains the digital signature formed by encrypting the generated erasure log with the secret key stored in the secret key storage unit 208. The digital signature generating unit 205 adds the obtained digital signature to the generated erasure log (B704). The data transmitting unit 202 then sends a notice of completion of the erasure processing to the host server 1 (B705).

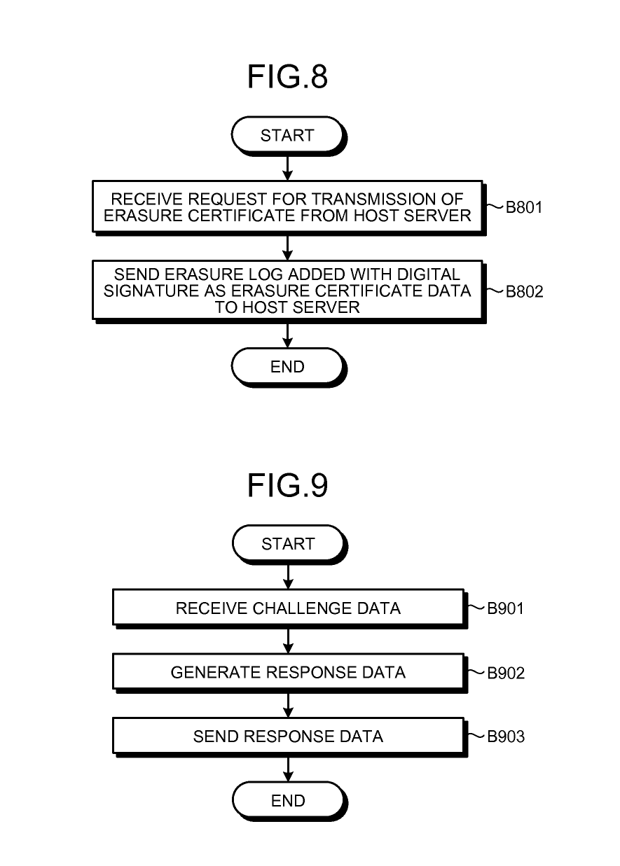

Next, by referring to FIG. 8, specific contents of the processing (the transmission processing of the erasure certificate data by the storage device 2 according to the present embodiment) executed by the storage device 2 in B509 to B511 of FIG. 5 will be described. FIG. 8 is a flowchart illustrating a flow of the transmission processing of the erasure certificate data by the storage device according to the first embodiment.

The data receiving unit 210 receives a request for transmission of the erasure certificate data from the host server 1 (B801). The data transmitting unit 202 receives the request for transmission of the erasure certificate data from the host server 1, and sends, as the erasure certificate data, the erasure log added with the digital signature in B704 of FIG. 7 to the host server 1 (B802).

Next, by referring to FIG. 9, specific contents of the processing (the transmission processing of the response data by the time server 3 according to the present embodiment) executed in the time server 3 in B504 and B505 of FIG. 5 will be described. FIG. 9 is a flowchart illustrating the transmission processing of the response data by the time server according to the first embodiment.

The CPU 11 controls the communication unit 16 to receive the challenge data from the storage device 2 via the host server 1 (B901). In response to the reception of the challenge data from the storage device 2, the CPU 11 generates response data that includes the time information regarding the generated time by the clocking unit 17 and the first random numbers included in the received challenge data (B902). In the present embodiment, the CPU 11 generates the digital signature obtained by encrypting the time information with the secret key. The CPU 11 then adds the generated digital signature to the response data as the authentication information. Thus, spoofing to the time server 3 or tampering of the time information can be prevented. The CPU 11 then controls the communication unit 16 to send the generated response data to the storage device 2 via the host server 1 (B903).

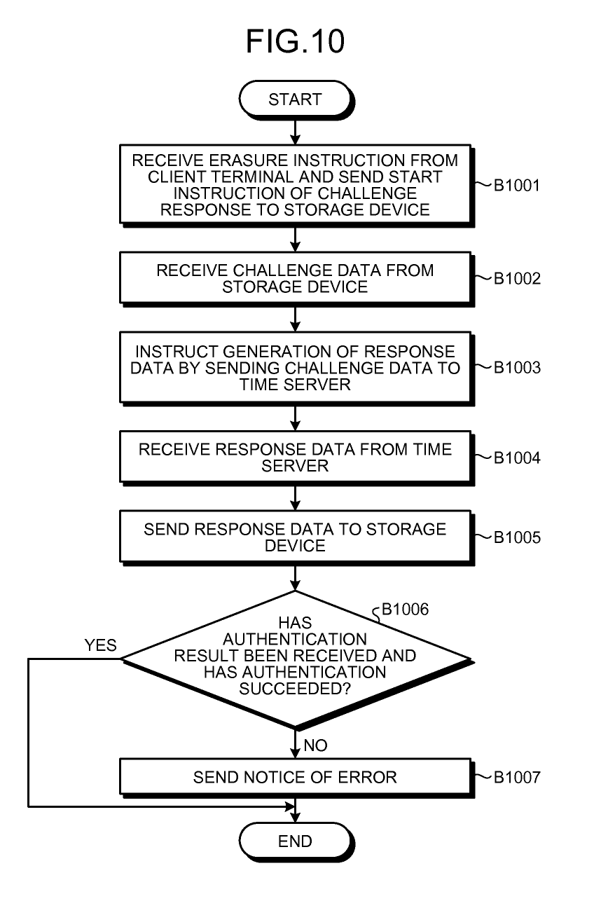

Next, by referring to FIG. 10, specific contents of the processing (the transmission processing of the response data by the host server 1 according to the present embodiment) executed by the host server 1 in B501 to B505 of FIG. 5 will be described. FIG. 10 is a flowchart illustrating a flow of the transmission processing of the response data according to the first embodiment.

The CPU 11 controls the communication unit 16 to receive the erasure instruction sent from the client terminal 4, and sends the start instruction of the challenge response to the storage device 2 (B1001). The CPU 11 then controls the communication unit 16 to receive the challenge data from the storage device 2 (B1002). Further, the CPU 11 sends the received challenge data to the time server 3 to instruct the time server 3 to generate the response data (B1003).

The CPU 11 (an example of receiving unit) controls the communication unit 16 to send the challenge data to the time server 3, and receives the response data from the time server 3 (B1004). The CPU 11 (an example of transmitting unit) controls the communication unit 16 to send the received response data to the storage device 2 which is the sender of the challenge data (B1005). The CPU 11 then controls the communication unit 16 to receive the authentication result of the time server 3 from the storage device 2 (B1006). According to the received authentication result, the CPU 11 further determines whether the authentication of the time server 3 has succeeded (B1006). If it is determined that the authentication of the time server 3 has failed (B1006: No), the CPU 11 sends, to the client terminal 4, the notice of error indicating unavailability of the erasure processing (B1007), and the processing ends. Meanwhile, if it is determined that the authentication of the time server 3 has succeeded (B1006: Yes), the CPU 11 ends the processing without sending the notice of error.

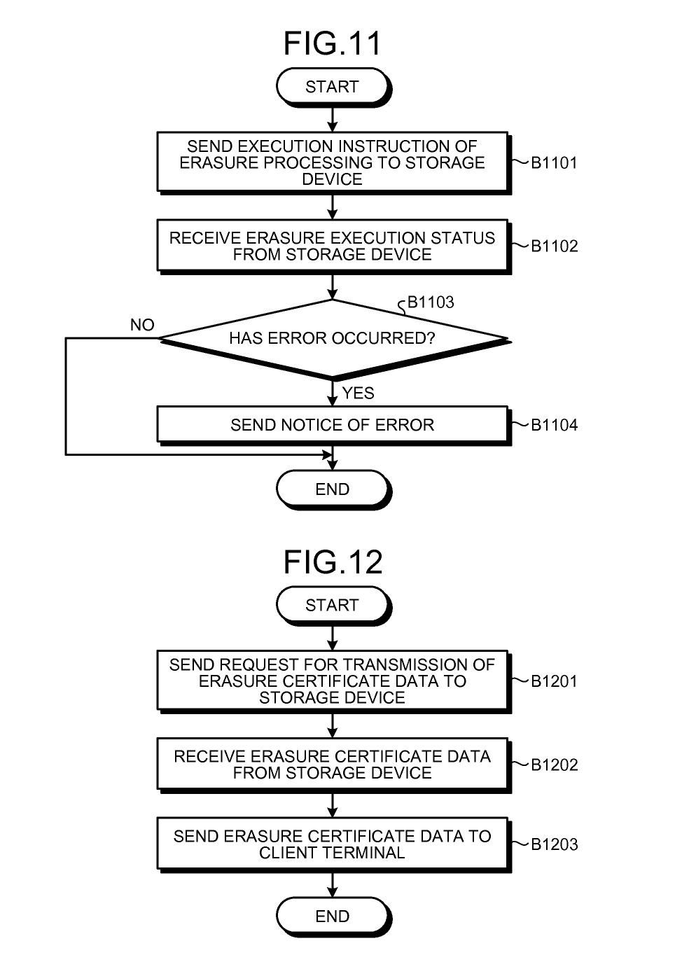

Next, by referring to FIG. 11, specific contents of the processing (the transmission of the execution instruction of the erasure processing by the host server 1 according to the present embodiment) executed by the host server 1 in B506 and B507 of FIG. 5 will be described. FIG. 11 is a flowchart illustrating a flow of transmission of execute instructions of the erasure processing by the host server according to the first embodiment.

If it is determined that the authentication of the time server 3 has succeeded (B1006 of FIG. 10: Yes), the CPU 11 sends the execution instruction of the erasure processing to the storage device 2 (B1101). The CPU 11 then controls the communication unit 16 to receive an erasure execution status that represents the status of the erasure processing (whether the error has occurred in the erasure processing, or the erasure processing has been completed normally) from the storage device 2 until the execution of the erasure processing has ended (B1102).

The CPU 11 determines whether the received erasure execution status indicates the occurrence of error in the erasure processing (B1103). If the received erasure execution status indicates the occurrence of the error (B1103: Yes), the CPU 11 controls the communication unit 16 to send a notice of error indicating unavailability of erasure processing to the client terminal 4 (B1104). Meanwhile, if the received erasure execution status does not indicate the occurrence of error in the erasure processing (B1103: No), the CPU 11 ends the processing without sending the notice of error.

Next, by referring to FIG. 12, specific contents of the processing (the transmission processing of the erasure certificate data by the host server 1 according to the present embodiment) executed by the host server 1 in B508 to B511 of FIG. 5 will be described. FIG. 12 is a flowchart illustrating a flow of transmission processing of the erasure certificate data by the host server according to the first embodiment.

In response to the notice of completion of the erasure processing sent from the storage device 2, the CPU11 controls the communication unit 16 to send a request for transmission of erasure certificate data to the storage device 2 (B1201). The CPU 11 then controls the communication unit 16 to receive the erasure certificate data from the storage device 2 (B1202). The CPU 11 controls the communication unit 16 to send the received erasure certificate data to the client terminal 4 (B1203).

Thus, in the storage device 2 according to the present embodiment, the erasure log including the highly reliable erasure time can be generated in the storage device 2 to which illegal access is difficult, and the highly reliable erasure log can be provided even when the illegal access is made to the host server 1.

### Second Embodiment

According to a second embodiment, the storage device 2 receives response data that includes random numbers (hereinafter referred to as second random numbers) which are generated by the time server 3 every time predetermined time (an example of fourth predetermined time) has passed. When the authentication of the time server 3 has succeeded, the storage server 2 generates the erasure log that includes the second random numbers having been included in the received response data and sends the generated erasure log to the client terminal 4 via the time server 3. In the description below, portions similar to those described in the first embodiment will not be described repeatedly.

First, the transmission processing of the response data to the time server 3 according to the present embodiment will be described. In the present embodiment, the CPU 11 of the time server 3 functions as a random number generating unit configured to generate second random numbers for predetermined time. The CPU 11 controls the communication unit 16 to receive the challenge data from the storage device 2 via the host server 1, and generates the response data including the second random numbers that have been generated last. The CPU 11 sends the generated response data to the storage device 2 via the host server 1.

Next, the transmission processing of the erasure certificate data in the storage device 2 according to the present embodiment will be described. The data receiving unit 210 receives, from the time server 3, the response data including the second random numbers generated in the time server 3 via the host server 1.

When the authentication of the time server 3 by the digital signature verifying unit 204 has succeeded and the erasure processing has been executed, the erasure certificate generating unit 211 then generates the erasure log including the second random numbers included in the received response data, in response to the request for transmission of the erasure certificate data received by the data receiving unit 210. In the present embodiment, the encryption operation unit 206 of the storage device 2 generates a digital signature obtained by encrypting the erasure log including the second random numbers with the secret key stored in the secret key storage unit 208. The digital signature generating unit 205 of the storage device 2 adds the generated digital signature to the erasure log including the second random numbers.

The data transmitting unit 202 sends the generated erasure log as the erasure certificate data to the client terminal 4 via the time server 3. In the present embodiment, the erasure certificate generating unit 211 and the data transmitting unit 202 function as an example of control unit.

Next, the transmission processing of the erasure certificate data by the time server 3 according to the present embodiment will be described. In the present embodiment, the CPU 11 of the time server 3 controls the communication unit 16 to receive the erasure certificate data sent from the storage device 2. When the second random number included in the received erasure certificate data matches the second random numbers generated between the time counted by the clocking unit 17 and the present time, the CPU 11 allows the transmission of the erasure certificate data to the client terminal 4.

Meanwhile, if the second random number included in the received erasure certificate data does not match the second random numbers generated between the time counted by the clocking unit 17 and the present time, the CPU 11 prohibits the transmission of the received erasure certificate data to the client terminal 4. Thus, transmission of less reliable erasure certificate data, which has been received after the extended time has passed since the transmission of the response data, to the client terminal 4 can be prevented.

For example, the CPU 11 may store the generation time when the second random numbers have been generated in the RAM 13 or the like, and read the second random numbers included in the received erasure certificate data from the RAM 13. If the read time is within a range of time allowed for transmission of the erasure certificate data, the CPU 11 may permit the transmission of the erasure certificate data to the client terminal 4. Meanwhile, if the read time is out of the range of time allowed for transmission of the erasure certificate data, the CPU 11 prohibits the transmission of the erasure certificate data to the client terminal 4.

In the present embodiment, if the second random number included in the received erasure certificate data matches the second random numbers generated between the time counted by the clocking unit 17 and the present time, the CPU 11 of the time server 3 obtains information obtained by decrypting the digital signature, which has been added to the erasure certificate data, with the public key of the storage device 2 having previously been stored in the ROM 12. When the authentication of the erasure certificate data has succeeded by using the information obtained by decrypting the digital signature added to the erasure certificate data, the CPU 11 sends the erasure certificate data to the client terminal 4 by adding the digital signature to the erasure certificate data.

Thus, the storage device 2 according to the second embodiment can prevent the transmission of less reliable data that has been received after the extended time has passed since the transmission of the response data to the client terminal 4.

According to the first and second embodiments, as described above, highly reliable erasure log can be provided even when the host server 1 is illegally accessed.

The programs to be executed in the host server 1 and the storage device 2 of the present embodiment are provided by previously incorporating the programs in the ROM or the like, but it is not limited thereto. Alternatively, the programs to be executed in the host server 1 and the storage device 2 of the present embodiment may be provided by recording them in a computer-readable storage medium such as a CD-ROM, a flexible disc (FD), a CD-R, or a digital versatile disk (DVD).

Further, the program to be executed by the host server 1 and the storage device 2 of the present embodiment may be stored on a network-connected computer, such as the one connected to the Internet, to allow downloading of the program via the network. The program to be executed by the host server 1 and the storage device 2 may be provided or distributed via the network such as the Internet.

The program to be executed in the storage device 2 of the present embodiment is provided in a module structure of the components described above (the data transmitting unit 202, the random number generating unit 203, the digital signature verifying unit 204, the digital signature generating unit 205, the encryption operation unit 206, the data erasing unit 209, the data receiving unit 210, and the erasure certificate generating unit 211). In the actual hardware structure, the CPU reads and executes the program from the ROM to load the above components on a main storage device, to thereby generate the data transmitting unit 202, the random number generating unit 203, the digital signature verifying unit 204, the digital signature generating unit 205, the encryption operation unit 206, the data erasing unit 209, the data receiving unit 210, and the erasure certificate generating unit 211 on the main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device, comprising:
a storage unit;
a receiving unit configured to receive, prior to execution of erasure processing of data stored in the storage unit, from an external device that clocks time, third information including first information and second information, the first information regarding time counted by the external device and the second information being information for authenticating the external device;
an authenticating unit configured to perform authentication processing of the external device by using the second information included in the third information; and
a control unit configured to generate, when the authentication of the external device has succeeded, an erasure log including erasure time when the erasure processing has been executed on the basis of the first information included in the third information, and to prohibit execution of the erasure processing when the authentication of the external device has failed.

2. The storage device of claim 1, wherein
the first information indicates time corresponding to timing when the first information has been received by the receiving unit, and
the control unit generates the erasure log including time that has passed between the reception of the third information and the end of the erasure processing, as the erasure time, on the basis of the time indicated by the first information.

3. The storage device of claim 1, wherein
the second information is a digital signature obtained by encrypting the first information, and
the authenticating unit determines that the authentication of the external device has succeeded when the first information included in the third information matches information obtained by decrypting the digital signature included in the third information, and that the authentication of the external device has failed when the first information included in the third information does not match the information obtained by decrypting the digital signature included in the third information.

4. The storage device of claim 1, wherein
the control unit prohibits execution of the erasure processing when first predetermined time has passed since the reception of the third information without execution of the erasure processing.

5. The storage device of claim 1, further comprising:
a generating unit configured to generate first random numbers each time second predetermined time has passed; and
a transmitting unit configured to transmit the first random numbers to the external device prior to the reception of the third information, wherein
the receiving unit receives the third information including the first random numbers and the first information, and
the control unit permits execution of the erasure processing when the first random numbers included in the third information match the first random numbers generated between the time indicated by the first information and third predetermined time, and prohibits execution of the erasure processing when the first random numbers included in the third information does not match the generated first random numbers.

6. The storage device of claim 1, wherein
the receiving unit receives the third information that includes second random numbers generated every time fourth predetermined time has passed in the external device, and
the control unit generates the erasure log including the second random numbers included in the received third information when the authentication of the external device has succeeded, and sends the generated erasure log to the client terminal via the external device.

7. An information processing apparatus comprising a control unit, wherein
when a first instruction to instruct execution of data erasure processing in an external storage device is input from a client terminal, the control unit receives, from an external device that clocks time, prior to execution of the erasure processing, third information including first information regarding time counted by the external device and second information for authenticating the external device, and sends the third information to the external storage device,
when the authentication of the external device has succeeded by using the second information, the control unit sends an erasure log generated on the basis of the first information in the external storage device and including the erasure time when the erasure processing is executed to the client terminal, and
the control unit notifies the client terminal of unavailability of executing the erasure processing when the authentication of the external device using the second information has failed.

8. An information processing method configured to be executed in a storage device including a storage unit, comprising:
receiving, from an external device that clocks time, prior to execution of erasure processing of data stored in the storage unit, third information including first information and second information, the first information regarding time counted by the external device and the second information being information for authenticating the external device,
performing authentication processing of the external device by using the second information included in the third information,
when the authentication of the external device has succeeded, generating an erasure log including erasure time when the erasure processing has been executed on the basis of the first information included in the third information, and
prohibiting execution of the erasure processing when the authentication of the external device has failed.

9. The information processing method of claim 8, wherein
the first information indicates time corresponding to timing when the first information has been received, and
the generating includes to generate the erasure log including time that has passed between the reception of the third information and the end of the erasure processing, as the erasure time, on the basis of the time indicated by the first information.

10. The information processing method of claim 8, wherein
the second information is a digital signature obtained by encrypting the first information, and
the authentication processing includes to determine that the authentication of the external device has succeeded when the first information included in the third information matches information obtained by decrypting the digital signature included in the third information, and that the authentication of the external device has failed when the first information included in the third information does not match the information obtained by decrypting the digital signature included in the third information.

11. The information processing method of claim 8, wherein
the prohibiting includes to prohibit execution of the erasure processing when first predetermined time has passed since the reception of the third information without execution of the erasure processing.

12. The information processing method of claim 8, further comprising:
generating first random numbers each time second predetermined time has passed; and
transmitting the first random numbers to the external device prior to the reception of the third information,
receiving the third information including the first random numbers and the first information,
permitting execution of the erasure processing when the first random numbers included in the third information match the first random numbers generated between the time indicated by the first information and third predetermined time, and
prohibiting execution of the erasure processing when the first random numbers included in the third information does not match the generated first random numbers.

13. The information processing method of claim 8, wherein
the receiving includes to receive the third information that includes second random numbers generated every time fourth predetermined time has passed in the external device, and
the generating includes to generate the erasure log including the second random numbers included in the received third information when the authentication of the external device has succeeded, and to send the generated erasure log to the client terminal via the external device.
